(19) United States
(12) Patent Application Publication
(10) Pub. No.: US 2003/0185020 A1
(43) Pub. Date: Oct. 2, 2003

(54) LED bulb for night-light

(75) Inventor: Albert Stekelenburg, Taipei (TW)

Correspondence Address: DOUGHERTY & TROXELL, 5205 LEESBURG PIKE, SUITE 1404, FALLS CHURCH, VA, 22041, US

(73) Assignee: All-Line Inc.

(21) Appl. No.: 10/107,197

(22) Filed: Mar. 28, 2002

(51) Int. Cl. F21V 7/04

(52) U.S. Cl. 362/555

(57) ABSTRACT

A LED bulb for night-light, comprising a screw base, a substrate which connected to said screw base, a circuit board which placed in said substrate for providing operation power, a LED connected to said circuit board for providing light, a transparent cover which connected to said substrate; thereby said LED bulb provided a power saving and long-life bulb for night-light.

### FIELD OF THE INVENTION

The present invention relates to a LED bulb, especially relates to a LED bulb which providing power saving and long-life.

### BACKGROUND OF THE INVENTION

Previously, The bulb which used for night-light using tungsten filament as lighting part for a long time, the maximum problem of the tungsten bulb is light without change and tungsten filament may be burned in a short-time, therefore, user must change bulb frequently.

Nowadays, due to the LED bulb has been developed many color light and has life longer than the tungsten filament bulb. So LED bulb could provide a power saving and long-life bulb for night-light.

The major object of the present invention is to provide a power saving and long-life bulb for night-light.

The secondary object of present invention is to provide a power saving and long-life plug embedded LED for night-light.

### SUMMARY OF THE INVENTION

The present invention provides a LED bulb for night-light, comprising a screw base, a substrate which connected to said screw base, a circuit board which placed in said substrate for providing operation power, a LED connected to said circuit board for providing light, a transparent cover which connected to said substrate; thereby said LED bulb provided a power saving and long-life bulb for night-light. The present invention also provides a plug embedded LED for night-light, comprising a body which has a circle hole, a circuit board which placed in said body for providing operation power, a LED connected to said circuit board for providing light; thereby said embedded LED plug plugged into the socket outlets then provided a power saving and long-life night-light.

### DESCRIPTION OF THE DRAWINGS

A complete understanding of the present invention may be obtained by reference to the accompanying drawings, when taken in conjunction with the detailed description thereof and in which:

FIG. 1: is a perspective, a LED bulb fabricate complete of the present invention.

FIG. 2: is a perspective drawing of a LED bulb fabricate complete of the present invention.

FIG. 3: is a perspective, parts sectional view of the present invention.

FIG. 4(a): is a perspective, parts sectional view of the circuit board of the present invention.

FIG. 4(b): is another perspective, parts sectional view of the circuit board of the present invention.

FIG. 4(c): is the other perspective, parts sectional view of the circuit board of the present invention.

FIG. 5: is a perspective, a plug embedded LED bulb fabricate complete of the present invention.

### DETAILED DESCRIPTION OF THE INVENTION

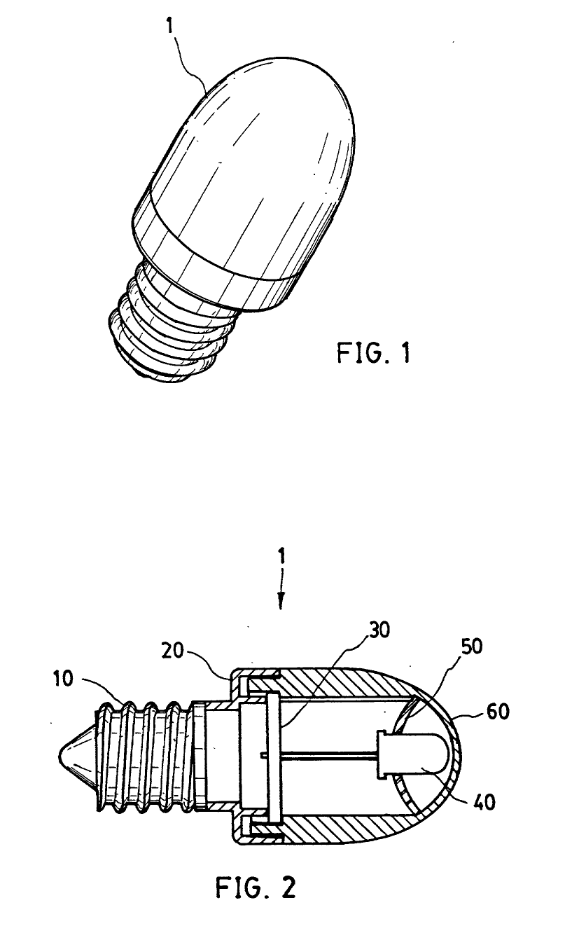

Referring to FIG. 1, it shows a LED bulb fabricate complete of the present invention. As shows in Fig.1 the appearance of the LED bulb of the present invention is different with the traditional tungsten filament bulb.

Referring to FIG. 2, it shows a perspective drawing of a LED bulb fabricate complete of the present invention. It shows the location of each elements of the LED bulb of the present invention in Fig.2.

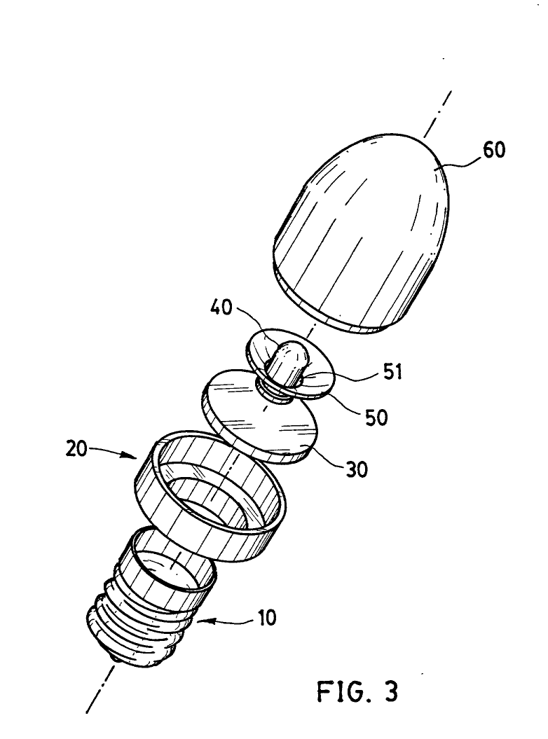

Referring to FIG. 3, it shows parts sectional view of the present invention. The LED bulb 1 for night-light, comprising a screw base 10, a substrate 20 which connected to said screw base 10, a circuit board 30 which placed in said substrate 20 for providing operation power, a LED 40 connected to said circuit board 30 for providing light, a transparent cover 60 which connected to said substrate 20; thereby said LED bulb 1 provided a power saving and long-life bulb for night-light.

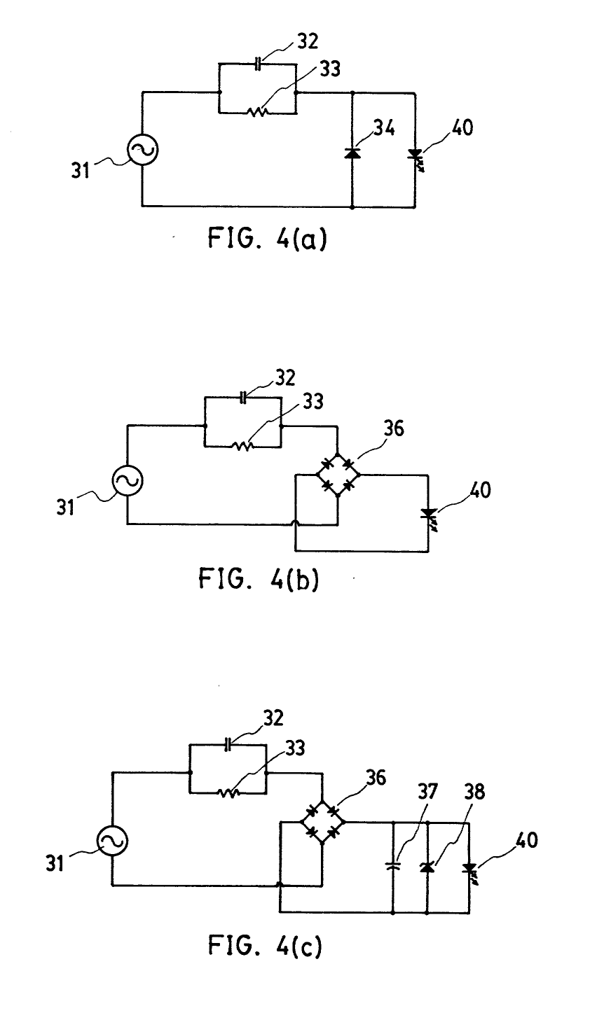

Refer to FIG. 4(a), it shows a parts sectional view of the circuit board of the present invention. Said circuit board 30 comprising a capacitor 32 connected to a AC Voltage 31 for step-down the AC Voltage 31 to around 2V, a resister 33 parallel to said capacitor 32 for providing a discharge loop and a LED protector 34 parallel to said LED 40 for protecting said LED 40. Wherein said LED protector 34 is a diode which has a opposite direction with said LED 40.

Refer to FIG. 4(b), it shows another parts sectional view of the circuit board of the present invention. Said circuit board 30 further comprising a capacitor 32 connected to a AC Voltage 31 for step-down the AC Voltage 31 to around 2V, a resister 33 parallel to said capacitor 32 for providing a discharge loop and a current commutator 36 connected to said capacitor 32 for commutation the step-down AC Voltage to a DC Voltage.

Refer to FIG. 4(c), it shows the other parts sectional view of the circuit board of the present invention. Said circuit board 30 further comprising a capacitor 32 connected to a AC Voltage 31 for step-down the AC Voltage 31 to around 2V, a resister 33 parallel to said capacitor 32 for providing a discharge loop, a current commutator 36 connected to said capacitor 32 for commutation the step-down AC Voltage to a DC Voltage and a locked capacitor 37 connected to said current commutator 36 for locking the DC Voltage after commutation and a Zener diode 38 parallel to said locked capacitor 37 for locking the DC Voltage too. Wherein said Zener diode 38 has a 2.0 V breakdown Voltage and a opposite direction with said LED 40.

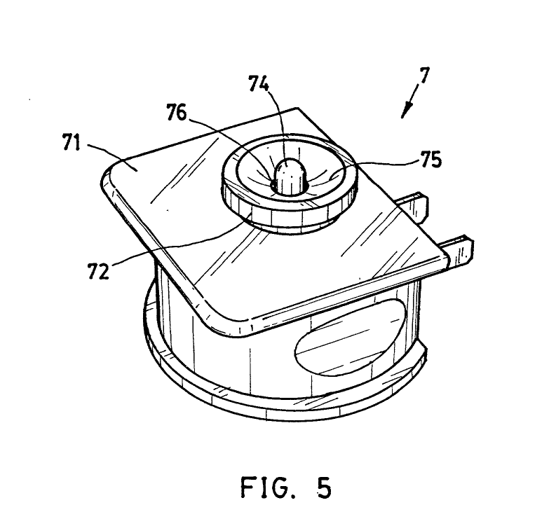

Fig.5 shows the second embodiment. A plug embedded LED 7 for night-light, comprising a body 71 which has a circle hole 72, a circuit board 30(figure not show) which placed in said body 71 for providing operation power, a LED 74 connected to said circuit board 30 for providing light; thereby said embedded LED plug 7 plugged into the socket outlets (figure not show) then provided a power saving and long-life night-light.

Concluded the above, the present invention was provided for a LED bulb which providing power saving and long-life and a plug embedded LED which providing power saving and long-life night-light.

While the present invention has been described with reference to preferred embodiments thereof, it is to be understood the modification or variations may be easily made without departing from the spirit of this invention, which is defined by the appended claims.

What is claimed is:

1. A LED bulb for night-light, comprising a screw base, a substrate which connected to said screw base, a circuit board which placed in said substrate for providing operation power, a LED connected to said circuit board for providing light, a transparent cover which connected to said substrate; thereby said LED bulb provided a power saving and long-life bulb for night-light.

2. The LED bulb as claimed in claim 1, wherein said circuit board further comprising a capacitor connected to a AC Voltage for step-down the AC Voltage, a resister parallel to said capacitor for providing a discharge loop and a LED protector parallel to said LED for protecting said LED.

3. The LED bulb as claimed in claim 1, wherein said circuit board further comprising a capacitor connected to the AC Voltage for step-down the AC Voltage, a resister parallel to said capacitor for providing a discharge loop and a current commutator connected to said capacitor for commutation the step-down AC Voltage to a DC Voltage.

4. The LED bulb as claimed in claim 1, wherein said circuit board further comprising a capacitor connected to the AC Voltage for step-down the AC Voltage, a resister parallel to said capacitor for providing a discharge loop, a current commutator connected to said capacitor for commutation the step-down AC Voltage to a DC Voltage, a locked capacitor connected to said current commutator for locking the DC Voltage and a Zener diode parallel to said locked capacitor for locking the DC Voltage too.

5. A plug embedded LED for night-light, comprising a body which has a circle hole, a circuit board which placed in said body for providing operation power, a LED connected to said circuit board for providing light; thereby said embedded LED plug plugged into the socket outlets then provided a power saving and long-life night-light.

6. The LED bulb as claimed in claim 5, wherein said circuit board further comprising a capacitor connected to a AC Voltage for step-down the AC Voltage, a resister parallel to said capacitor for providing a discharge loop and a LED protector parallel to said LED for protecting said LED.

7. The LED bulb as claimed in claim 5, wherein said circuit board further comprising a capacitor connected to the AC Voltage for step-down the AC Voltage, a resister parallel to said capacitor for providing a discharge loop and a current commutator connected to said capacitor for commutation the step-down AC Voltage to a DC Voltage.

8. The LED bulb as claimed in claim 5, wherein said circuit board further comprising a capacitor connected to the AC Voltage for step-down the AC Voltage, a resister parallel to said capacitor for providing a discharge loop, a current commutator connected to said capacitor for commutation the step-down AC Voltage to a DC Voltage, a locked capacitor connected to said current commutator for locking the DC Voltage and a Zener diode parallel to said locked capacitor for locking the DC Voltage too.
